(19) United States
(12) Patent Application Publication
(10) Pub. No.: US 2002/0155227 A1
(43) Pub. Date: Oct. 24, 2002

(54) Method for the manufacture of a functional ceramic layer

(75) Inventors: Rajiv Damani, Winterthur (CH); Andreas F.J. Kaiser, Elgg (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer markets and Technolgy AG, Winterthur (CH)

(21) Appl. No.: 10/101,810

(22) Filed: Mar. 19, 2002

(30) Foreign Application Priority Data
Apr. 23, 2001 (EP) 01810390.3

(51) Int. Cl. B05D 3/02

(52) U.S. Cl. 427/453; 427/376.1; 427/376.2

(57) ABSTRACT

The method for the manufacture of a functional ceramic layer (10) comprises the following two steps:

in the first step, ceramic coating material is applied to a substrate in powder or slurry form and thermally solidified to form a raw layer (1)—for example by means of a thermal spraying process or of a screen printing process and subsequent sintering. The coating material has suitable properties with respect to the intended function of the layer. The function relates to electrical or electrochemical properties.

In the second step, the raw layer is modified by an application such that capillary spaces (2) of the raw layer are sealed by the application and the intended function of the overall layer is improved. A liquid is used as the sealant (3) which consist of a solvent and at least one salt of a metal (Me) contained therein which can be thermally converted into a metal oxide. The sealant is applied to the surface (20) of the raw layer. Furthermore the solvent is evaporated at increasing temperature (4) heat supply—after waiting for a penetration (30) into the capillary spaces—and the metal is converted into the metal oxide at an elevated temperature.

The invention relates to a method for the manufacture of a functional ceramic layer and uses of the method for the manufacture of particular layers. A ceramic layer is as a rule a coating which is applied to a substrate. However, it can also be an insulated membrane which, for example, is manufactured by means of a band casting process. A ceramic layer is also to be understood as a layer which also contains metallic components in addition to ceramic ones.

Ceramic layers or membranes can be manufactured by means of various methods: a) from a powdered coating material and thermal injection (e.g. plasma spraying, flame spraying or detonation coating); b) by material deposition from the vapour phase (PVD, EBPVD, CVD); c) by means of a material prepared as a slurry and by a band casting or screen printing process with subsequent sintering. Layers manufactured with such processes often contain capillary spaces which are formed by pores and open crack structures and which impair an intended function of the layer.

An example: the high temperature fuel cell. In this, electrode reactions are carried out on an electro-chemically active membrane for the generation of an electric current; that is a reducing reaction at the anode in which water and carbon dioxide are produced from the hydrogen and carbon monoxide of a first gas flow; and an oxidising reaction at the cathode in which ionic oxygen O₂₋ is formed from molecular oxygen of a second gas flow while taking up electrons from a metallic conductor. The oxygen ions move through a solid electrolyte which separates the two electrodes in gas tight manner and which is conductive for the oxygen ions at temperatures above 700° C. The reducing anode reaction with the oxygen ions takes place while emitting electrons to a further metallic conductor which makes a connection to an adjacent electro-chemically active membrane or to a battery terminal. The electro-chemically active membrane is a multi-layer system in whose manufacture every layer can be used as a carrier for one or more adjacent layers. The carrier layer is the substrate on which a functional layer is applied, for example by a thermal spraying process or using a screen printing process. It is a requirement for a fault-free functioning of the fuel cell that the solid electrolyte layer is gas tight and a good conductor for the oxygen ions.

It is the object of the invention to provide a method which, starting from one of the above methods, allows the manufacture of a ceramic layer which has an improved function with respect to electric or electrochemical properties. This object is satisfied by the method defined in claim 1.

The method for the manufacture of a functional ceramic layer comprises the following two steps: In the first step, ceramic coating material in powder or slurry form is applied to a substrate and thermally solidified into a raw layer, for example by means of a thermal spraying process or of a screen printing process and subsequent sintering. The coating material has suitable properties with respect to a given or intended function of the layer. The function is related to electric or electro-chemical properties. In the second step, the raw layer is modified by an application such that capillary spaces in the raw material are sealed by the application and the intended function of the overall layer is improved. A fluid is used as the sealant which consists of a solvent and of at least one salt of a metal contained therein that can be thermally converted into a metal oxide. The sealant is applied to the surface of the raw layer. Furthermore,—after waiting for a penetration into the capillary spaces—the solvent is evaporated as the temperature increases under heat input and the metal changes into the metal oxide at an elevated temperature.

The dependent claims 2 to 8 relate to advantageous embodiments of the method of the invention. Possible uses of the method of the invention are the subjects of claims 9 and 10 respectively.

One of the following ceramic materials or a mixture of these materials can, for example, be used as the coating material for a thermally sprayed layer; that is oxides of the metals Me=Zr, Ce, Y, Al or Ca. Aqueous solutions of the nitrates Me(No₃)ₓ can be used—according to the metals Me—as the sealant, where x=2 for Ca and x=3 for Zr, Ce Y or Al. The metal nitrates are as a rule available as crystalline hydrates, for example Ce(No₃)₃.6H₂O, which are easily soluble in water. Heavy metal nitrates decompose into the corresponding oxides (for example Ce₂O₃) at elevated temperatures while simultaneously forming gaseous NO₂. The conversion temperature at which oxide formation results is between around 200° C. to 350° C. As the temperature increases, the treatment time reduces (for example, 15 min at 350° C., 10 min at 400° C.

The invention is explained in the following with reference to the drawings, in which are shown:

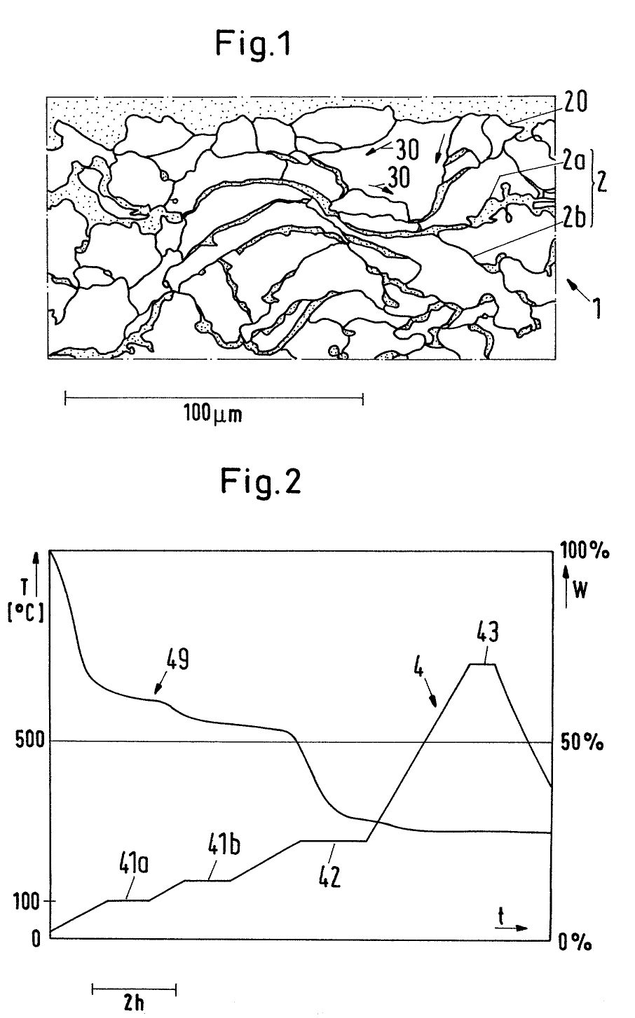

FIG. 1a section through a raw layer manufactured by plasma spraying, drawn according to a picture taken with a scanning electron microscope;

FIG. 2 for a heat treatment of the raw layer, a diagram with time profiles of the temperature and of the weight loss incurred in the treatment;

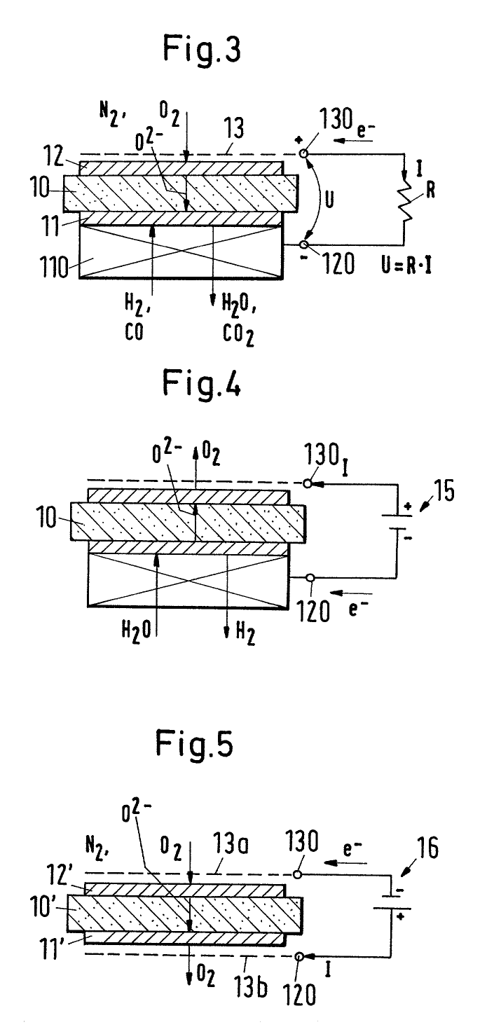

FIG. 3a schematic representation of a fuel cell;

FIG. 4a corresponding representation of a cell with which a high temperature water electrolysis can be carried out;

FIG. 5a representation of a further cell with which pure oxygen can be gained from air; and

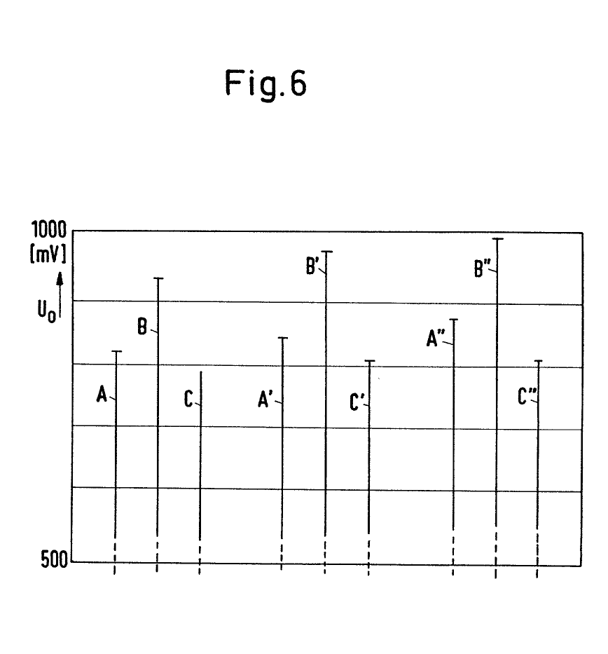

FIG. 6a graphic representation of measurement results with respect to a fuel cell whose solid electrolyte has been made according to the method of the invention.

The layer of FIG. 1 drawn in accordance with a scanning electron microscope picture is shown magnified by approximately 700 times. This layer, of which only a section is shown, is a raw layer 1 of the method of the invention. It is made from a powdered, ceramic material—namely YSZ, i.e. zirconium oxide ZrO₂ stabilised with yttrium Y—which has been formed into a thermally solidified layer by means of plasma spraying. A raw layer 1 can, for example, also be made using a screen printing method, with thermal solidification taking place by means of sintering. The raw layer 1 has capillary spaces 2 which comprise pores 2a and cracks 2b.

After the manufacture of the raw layer 1, this is modified in a second step by an application such that an intended function of the overall layer improves. The capillary spaces 2 are sealed by the application. A liquid is used as the sealant 3 which consists of a solvent and at least one oxidisable metal Me contained therein, in particular zirconium Zr. The metals Me are present in the form of cations; the corresponding anions are anorganic compounds, for example nitrate NO3-, or organic compounds, for example alcoholates or acetates. If alcoholates are used, then chelate ligands, such as acetyl acetonate, are advantageously added, which greatly decrease the hydrolysis sensitivity of the alcoholates which exists with respect to air humidity. This prevents a flocculation of the oxides in the sealing process. The sealant 3 is applied to the surface 20 of the raw layer 1. It penetrates into the capillary spaces 2 due to capillary forces: see the arrows which indicate a penetration 30. After waiting for the penetration 30 of the sealant 3 into the capillary spaces 2, a heat treatment is performed. The solvent of the sealant 3 is evaporated under thermal input as the temperature increases; the metal Me oxidises at an elevated temperature (Me=Zr is oxidised to ZrO₂; the nitrate ions react to form NO₂).

The sealant 3 is advantageously an aqueous solution which contains a salt of the oxidisable metal Me in dissolved form. The oxidised metal is insoluble in water. The metal salt is preferably a nitrate or acetate (or a mixture) of the metals Me=Co, Mn, Mg, Ca, Sr, Y, Zr, Al, Ti and/or of a lanthanide, in particular of one of the lanthanides Ce, Eu or Gd. The sealant 3 is advantageously a saturated, solid-free solution whose viscosity at 20° C. is lower than 150 mPa s, preferably lower than 35 mPa s.

A tenside is advantageously added to the sealant 3 by which the wetting angle and the surface tension of this liquid is suitably reduced with respect to the material of the raw layer 1, so that the greatest possible depth of penetration results and thus the greatest possible amount of sealant penetrates into the capillary spaces 2.

In the heat treatment, the heat input can be carried out in a thermal oven, in a microwave oven, with a heat radiator, in particular a carbon radiator having a wavelength range from 2-3.5 μm, and/or with a flame.

A multiple repetition of the sealing application is generally necessary for the sealing. The application consists in each case of an application of the sealant 3 and the heat treatment which is described in more detail with reference to FIG. 2:

The heat supply is carried out in accordance with a pre-determined temperature profile 4 with respect to time. The temperature profile 4 comprises intervals, within which the temperature is respectively held at least approximating at a level 41a, 41b and 42. Solvent is evaporated at the first two levels. The evaporation takes place at the first level 41a at a temperature T at which no vapour bubbles are formed. Such bubbles would again drive a part of the sealant out of the capillary spaces 2. The layer 1 is cured at a further level 42; the metal Me is oxidised at a temperature which is greater than a conversion temperature dependent on the oxidisable metal Me. The curve 49 shows how the weight w of the layer 1 reduces as a result of evaporating components of the sealant and of the conversion. After the heat treatment has been carried out, the layer 1 is finally exposed to an even higher temperature at a level 43, said temperature corresponding to the operating temperature of the functional layer 1. New cracks can form during this tempering treatment which are sealed in a further sealing application.

The result of the method of the invention is a layer 10 which can be used, for example, as a solid electrolyte in a high temperature fuel cell, see FIG. 3. The solid electrolyte layer 10 is an ion conducting connection between the cathode 12 and the anode 11 at higher temperatures (of at least around 700° C.). The anode 11 is a barrier layer of a gas permeable carrier structure 110. The layer 10 can be applied to the carrier structure 110 by means of a coating method (it is then an ASE cell—an “Anode Supported Electrolyte” cell). An electrical voltage U and a current I (at a load R) are produced with oxygen from air (around 20% O₂, 80% N₂) and the reducing gases hydrogen H₂ and carbon monoxide CO. The reaction products are H₂O and CO₂. A first pole 120 is connected to the electrically conductive carrier structure 110. A second pole 130 is in connection with a current collector 13 which is connected to the cathode via a plurality of contact points, via which electrons e⁻ are fed into the cathode.

The fuel cell is a power supply. Its function can be reversed by applying a power supply 15 externally to the terminals 120 and 130: see FIG. 4. With this reversal, water vapour, H₂O, can be split by electrolysis into the components H₂ and O₂ and these components can be obtained separately.

FIG. 5 shows a further cell with which pure oxygen can gained from air. In this case, the solid electrolyte layer is formed as a membrane 10′. This membrane 10′ is a semi-permeable membrane through which the oxygen converted at the electrode 12′ into ions O²⁻ is transported under the driving force of a power source 16 and is separated from the other components of the air—predominately N₂. At the other electrode 11′, the oxygen ions are discharged again and set free as pure oxygen gas. The poles 120 and 130 are connected to the electrodes 11′, 12′ via electrical conductors 13a and 13b.

With the said ASE cell, particular measures have to be provided if the electrolyte layer 10 sprayed onto the anode 11 is sealed. Pores of the substrate, i.e. the carrier structure 110, are advantageously filled with a medium which can be removed without residue prior to the carrying out of the second step. Media of this kind are organic materials, in particular lacquers or resins, which can be removed thermolytically and which evaporate during the heat treatment of the method of the invention.

It has been demonstrated for different sealants that a solid electrolyte layer of YSZ receives an improved ion conductivity as a result of the method of the invention. Results of trials are shown in FIG. 6:

A fuel cell was manufactured with the solid electrolyte to be investigated and the voltage U₀ for this determined with insulated terminals 120, 130 (FIG. 3), with pure hydrogen being used as the reducing gas with different flow rates. The results for three flow rates (the pressure difference between inlet and outlet respectively 10, 20 or 30 mm water column) are shown in FIG. 6. A reference sample (measured values A, A′, A″, corresponding to the different flow rates) were compared with sealed samples. The reference sample was subjected to the same heat treatment as the samples treated in accordance with the invention. Sealing with a sealant containing zirconium, in which the sealing application had been carried out five times with a nitrate solution, produces positive results (measuring values B, B′, B″); the voltage U₀ increased substantially due to an improved ion conductivity. Similarly good results (not shown) were obtained with a Ce sealing and sealings with a doped Ce or an alternating use of sealant containing Ce and Zr. A sealing process in which Al₂O₃ was formed in the capillary spaces 2 produced worse results (measured values C, C′, C″). The reason for the reduction in the voltage U₀ is that Al₂O₃ is an insulator which hinders a transport of oxygen ions.

The last result shows that the method of the invention can also be used to improve the insulation property of an electrically insulating layer. Analogously, the electrical conductivity of an electrically conductive layer can also be improved.

1. A method for the manufacture of a functional ceramic layer (10) comprising the following two steps:
in the first step, ceramic coating material is applied to a substrate in powder or slurry form and thermally solidified to form a raw layer (1)—for example by means of a thermal spraying process or of a screen printing process and subsequent sintering—with the coating material having suitable properties with respect to the intended function of the layer and with the function relating to electrical or electro-chemical properties;
in the second step, the raw layer is modified by an application such that capillary spaces (2) of the raw layer are sealed by the application and the intended function of the overall layer is improved, with a liquid being used as the sealant (3) which consist of a solvent and at least one salt of a metal (Me) contained therein which can be thermally converted into a metal oxide and with the sealant being applied to the surface (20) of the raw layer, furthermore, with the solvent being evaporated at increasing temperature (4) by heat supply—after waiting for a penetration (30) into the capillary spaces—and the metal being converted into the metal oxide at an elevated temperature.

2. A method in accordance with claim 1, characterised in that the sealing of the layer (1) is carried out by a single or multiple repetition of the application; and in that the application consists of the application of the sealant (3) and the heat supply in order to achieve the said purposes.

3. A method in accordance with claim 1, characterised in that the heat supply is carried out in accordance with a pre-determined temperature profile (4) with respect to time, with the temperature profile comprising intervals, within which the temperature is held at least approximating at a level (41a, 41b, 42), with solvent, water of crystallisation and added organic additives being evaporated at a first and optionally a second level (41a, 41b) and with the metal salt being transformed into the oxide at a further level (42), at a temperature which is greater than a conversion temperature dependent on the metal salt.

4. A method in accordance with any of claims 1 to 3, characterised in that the sealant (3) is an aqueous solution which contains a salt of the oxidisable metal (Me) in dissolved form; in that the oxidised metal is insoluble in water; and in that the metal salt is preferably a nitrate or acetate of the metals Co, Mn, Mg, Ca, Sr, Y, Zr, Al, Ti and/or of a lanthanide, in particular one of the lanthanides Ce, Eu or Gd.

5. A method in accordance with any of claims 1 to 4, characterised in that the sealant (3) is a saturated, solid-free solution whose viscosity at 20° is lower than 150 mPa s, preferably lower than 35 mPa s.

6. A method in accordance with any of claims 1 to 5, characterized in that a tenside is added to the sealant (3) with which the wetting angle and the surface tension of this liquid is suitably reduced with respect to the material of the raw layer (1) such that the largest possible penetration depth results or the largest possible amount of sealant which penetrates into the capillary spaces (2).

7. A method in accordance with any of claims 1 to 6, characterised in that the heat input is carried out in a thermal oven, in a microwave oven, with a radiator of heat, in particular a carbon radiator with a wavelength range from 2-3.5 μm, and/or with a flame.

8. A method in accordance with any of claims 1 to 6, characterized in that pores of the substrate are filled with a means removable without residue, in particular an organic material, prior to the carrying out of the second step.

9. Use of the method in accordance with any of claims 1 to 8 for an improvement of the ion conductivity of a solid electrolyte layer (10; 10′), for example the conductivity of oxygen ions in the solid electrolyte of a high temperature fuel cell, of a high temperature oxygen generator or of a high temperature electrolysis apparatus.

10. Use of the method in accordance with any of claims 1 to 8 for an improvement of the electrical conductivity of an electrically conductive layer or an improvement of the insulation property of an electrically insulating layer.
